(19) United States
(12) Patent Application Publication
(10) Pub. No.: US 2007/0188080 A1
(43) Pub. Date: Aug. 16, 2007

(54) FLAT FLUORESCENT LAMP AND LIQUID CRYSTAL DISPLAY DEVICE HAVING THE SAME

(75) Inventors: Hae-Il PARK, Seoul (KR); Jin-Seob BYUN, Seoul (KR); Sang-Yu LEE, Yongin-si (KR); Don-Chan CHO, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/549,504

(22) Filed: Oct. 13, 2006

(30) Foreign Application Priority Data
Feb. 10, 2006 (KR) 10-2006-0012952

(51) Int. Cl. H01J 1/62

(52) U.S. Cl. 313/504; 313/512; 313/506

(57) ABSTRACT

A flat fluorescent lamp including a first substrate, a second substrate facing the first substrate to provide a discharge region having a plurality of discharge spaces and a non-discharge region encompassing the discharge region. Fluorescent layers are arranged on the first and second substrates, and a sealing member is arranged in the non-discharge region shielded from the discharge spaces, and it couples the first and second substrates together.

### CROSS REFERENCE TO RELATED APPLICATION

This application claims priority from and the benefit of Korean Patent Application No. 10-2006-0012952, filed on Feb. 10, 2006, which is hereby incorporated by reference for all purposes as if fully set forth herein.

### BACKGROUND OF THE INVENTION

1. Field of the Invention

The present invention relates to a flat fluorescent lamp (FFL) and a liquid crystal display (LCD) device having the same, and more particularly, to an FFL having a sealing member that is not exposed to a discharge space, and an LCD device having the same.

2. Discussion of the Background

Generally, LCD devices are widely used because they may be made light and thin, and they require relatively low driving voltage and power consumption. The LCD device supplies an electric field to a liquid crystal material that is arranged between two substrates and has dielectric anisotropy. The amount of light transmitted onto the substrates may be controlled by adjusting the intensity of the electric field, thus displaying a desired image.

Since an LCD panel of the LCD device cannot emit light by itself, the LCD device includes a backlight unit to provide light to the LCD panel.

An FFL used for the backlight unit includes first and second substrates facing each other to provide a plurality of discharge spaces. The first substrate is bonded to the second substrate with a sealing member disposed therebetween. Since the sealing member is exposed to the discharge spaces, it is directly exposed to plasma discharge and a high electric field formed in the discharge spaces. In this case, the sealing member may form a dendrite, which has a tendency to grow over time. Formation of the dendrite lowers outer appearance quality and negatively affects uniformity of a light emitting region, thereby deteriorating the quality of the FFL when the FFL is driven for a long time.

### SUMMARY OF THE INVENTION

The present invention provides an FFL in which a sealing member is not exposed to a discharge space, and an LCD device having the same.

Additional features of the invention will be set forth in the description which follows, and in part will be apparent from the description, or may be learned by practice of the invention.

The present invention discloses an FFL including a first substrate, a second substrate facing the first substrate to provide a discharge region comprising a plurality of discharge spaces and a non-discharge region. A fluorescent layer is arranged in the discharge spaces on at least one of the first and second substrates, and a sealing member is arranged in the non-discharge region and shielded from the discharge spaces. The sealing member couples the first and second substrates together.

The present invention also discloses an LCD device comprising a flat fluorescent lamp and a liquid crystal display panel for displaying an image with light from the flat fluorescent lamp. The flat fluorescent lamp includes a first substrate, a second substrate facing the first substrate to provide a discharge region comprising a plurality of discharge spaces and a non-discharge region encompassing the discharge region. A fluorescent layer is arranged on at least one of the first and second substrates, and a sealing member is arranged in the non-discharge region shielded from the discharge spaces. The sealing member couples the first and second substrates together.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of an FFL according to a first exemplary embodiment of the present invention.

FIG. 2 is a cross-sectional view of the FFL taken along line I-I′ of FIG. 1.

FIG. 3 is a cross-sectional view of an FFL according to a second exemplary embodiment of the present invention.

FIG. 4 is a cross-sectional view of an FFL according to a third exemplary embodiment of the present invention.

FIG. 5 is a cross-sectional view for describing a process of forming the sealing member of FIG. 4.

FIG. 6 is a cross-sectional view of an FFL according to a fourth exemplary embodiment of the present invention.

FIG. 7 is a cross-sectional view showing another example of the FFL of FIG. 6.

FIG. 8 is a perspective view of an LCD device having an FFL according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

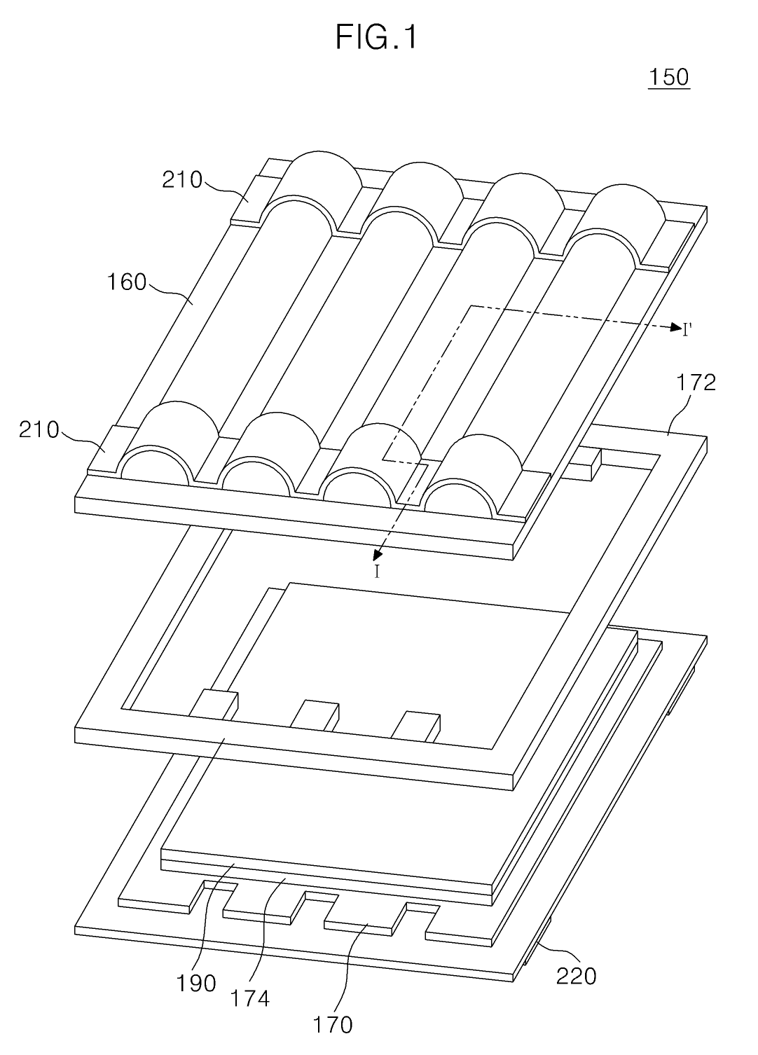

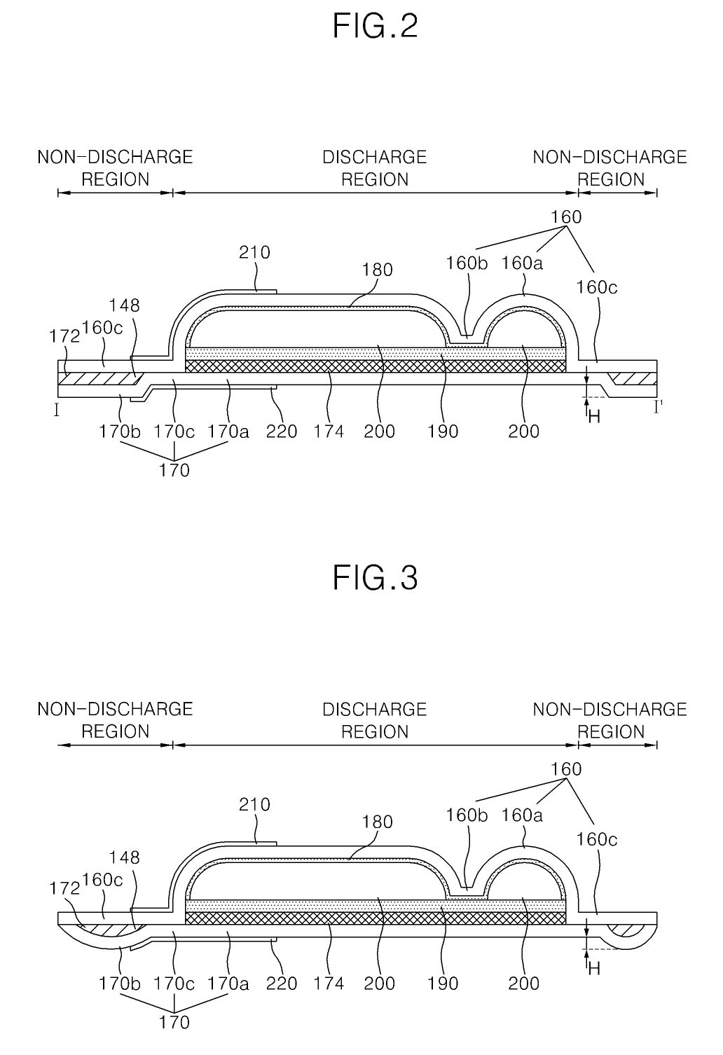

FIG. 1 is a perspective view of an FFL according to a first exemplary embodiment of the present invention, and FIG. 2 is a cross-sectional view of the FFL taken along line I-I′ of FIG. 1.

Referring to FIG. 1 and FIG. 2, an FFL 150 includes first and second substrates 160 and 170 facing each other to provide a plurality of discharge spaces 200 and a sealing member 172 formed between the first and second substrates 160 and 170 to bond them together.

An upper fluorescent layer 180 is formed on the back of the first substrate 160, and upper electrodes 210 are formed at outer sides of the front of the first substrate 160.

The first substrate 160 is formed of a transparent material, such as glass, so that it may transmit visible light. The first substrate 160 includes a space provider 160a and a space partition 160b, which are alternately formed in a discharge region, and a plane portion 160c, which is formed in a non-discharge region. The space provider 160a is spaced apart from the second substrate 170 by a first distance, and it forms the plurality of discharge spaces 200 together with the second substrate 170. A vertical cross section of the space provider 160a may be semicircular, semielliptic, or polygonal. The space partition 160b has a planar surface between the discharge spaces 200, and it is spaced apart from the second substrate 170 by a second distance, which is less than the first distance. The plane portion 160c has a planar surface, and it faces a contact portion 170c and a filling portion 170b of the second substrate 170.

The upper electrodes 210 are formed at edges of both sides of the front of the first substrate 160 to cross the discharge spaces 200. A discharge voltage for creating a plasma discharge within the discharge spaces 200 is supplied to the upper electrodes 210. The upper electrodes 210 may be formed of a conductive material, such as copper (Cu), nickel (Ni), silver (Ag), gold (Au), aluminum (Al) and chrome (Cr), or of a transparent conductive material, such as indium-tin-oxide (ITO) and indium-zinc-oxide (IZO).

A light-reflecting layer 174 and a lower fluorescent layer 190 are sequentially formed on the front of the second substrate 170, and lower electrodes 220 are formed on the back thereof.

The second substrate 170 may be formed of a transparent material, such as glass, and transmits visible light. The second substrate 170 includes a discharge portion 170a formed in the discharge region, the filling portion 170b formed in the non-discharge region, and the contact portion 170c formed between the discharge portion 170a and the filling portion 170b.

The discharge portion 170a faces the space provider 160a and space partition 160b of the first substrate 160 to form the discharge spaces 200. The filling portion 170b is spaced apart from the plane portion 160c by a given distance to provide space for the sealing member 172. The filling portion 170b is stepped with respect to the discharge portion 170a and the contact portion 170c. For example, the filling portion 170b may be formed with a step height H of about 0.5 to 1 mm from the contact portion 170c. The contact portion 170c extends from the discharge portion 170a and contacts the plane portion 160c of the first substrate 160. Accordingly, the contact portion 170c of the second substrate 170 and the plane portion 160c of the first substrate 160 prevent the sealing member 172 from being exposed to the discharge space 200.

The light-reflecting layer 174 reflects light generated by the upper and lower fluorescent layers 180 and 190 toward the first substrate 160, thereby preventing light leakage through the second substrate 170.

The lower fluorescent layer 190 faces the upper fluorescent layer 180. A discharge in the discharge spaces 200 causes a discharge gas to generate plasma, which generates ultraviolet light. The ultraviolet light then excites the upper and lower fluorescent layers 180 and 190, which then emit visible light.

The lower electrodes 220 are formed at edges of both sides of the back of the second substrate 170 to cross the discharge spaces 200. A discharge voltage for creating a plasma discharge within the discharge spaces 200 is supplied to the lower electrodes 220, which may be formed of the same material as the upper electrodes 210.

The sealing member 172 is arranged in the space between the filling portion 170b of the second substrate 170 and the plane portion 160c of the first substrate 160. The sealing member 172 may be formed of, for example, a frit glass. At least two discharge spaces 200 are provided by bonding the first substrate 160 to the second substrate 170 with the sealing member 172. The discharge spaces 200 include a discharge gas, which may include mercury (Hg), neon (Ne) or argon (Ar).

An electrode partition 148, which is formed of the same material as the sealing member 172, is formed between the filling portion 170b and the space partition 160b overlapping the upper electrodes 210 to divide the electrodes 210 and 220 according to the discharge spaces.

As described above, in the FFL according to the first exemplary embodiment of the present invention, the sealing member 172 is formed in a space between the filling portion 170b of the second substrate 170 and the plane portion 160c of the first substrate 160. The plane portion 160c contacts the contact portion 170c of the second substrate 170, thereby preventing the sealing member 172 from leaking into the discharge space 200. Moreover, the amount of the sealing member 172 formed at the filling portion 170b may be adjusted by controlling the step height of the filling portion 170b. Furthermore, since the sealing member 172 is formed at the filling portion 170b of the second substrate 170 and at the plane portion 160c of the first substrate 160, separation between the first and second substrates 160 and 170 may be controlled according to flatness of the first substrate 160.

FIG. 3 is a cross-sectional view of an FFL according to a second exemplary embodiment of the present invention.

The FFL shown in FIG. 3 has the same configuration as that shown in FIG. 1 and FIG. 2, except that the filling portion of the second substrate is formed in a closed form. Therefore, a detailed description of the same elements will be omitted.

Referring to FIG. 3, the filling portion 170b of the second substrate 170 is arranged with the plane portion 160c of the first substrate 160 to provide a closed space for forming the sealing member 172. The closed space may have a semicircular, semielliptic or polygonal cross section. The filling portion 170b is formed to have a step height H of about 0.5 to 1 mm from the contact portion 170c.

The closed space between the filling portion 170b and the plane portion 160c is filled with the sealing member 172. The sealing member 172 may be filled in the closed space by fusion bonding at a high temperature, thereby preventing the sealing member from flowing.

Thus, in the FFL according to the second exemplary embodiment of the present invention, the sealing member 172 is formed in a closed space between the filling portion 170b of the second substrate 170 and the plane portion 160c of the first substrate 160. Since the first substrate 160 contacts the contact portion 170c of the second substrate 170, the sealing member 172 formed at the filling portion 170b may be prevented from being exposed to the discharge space and from flowing.

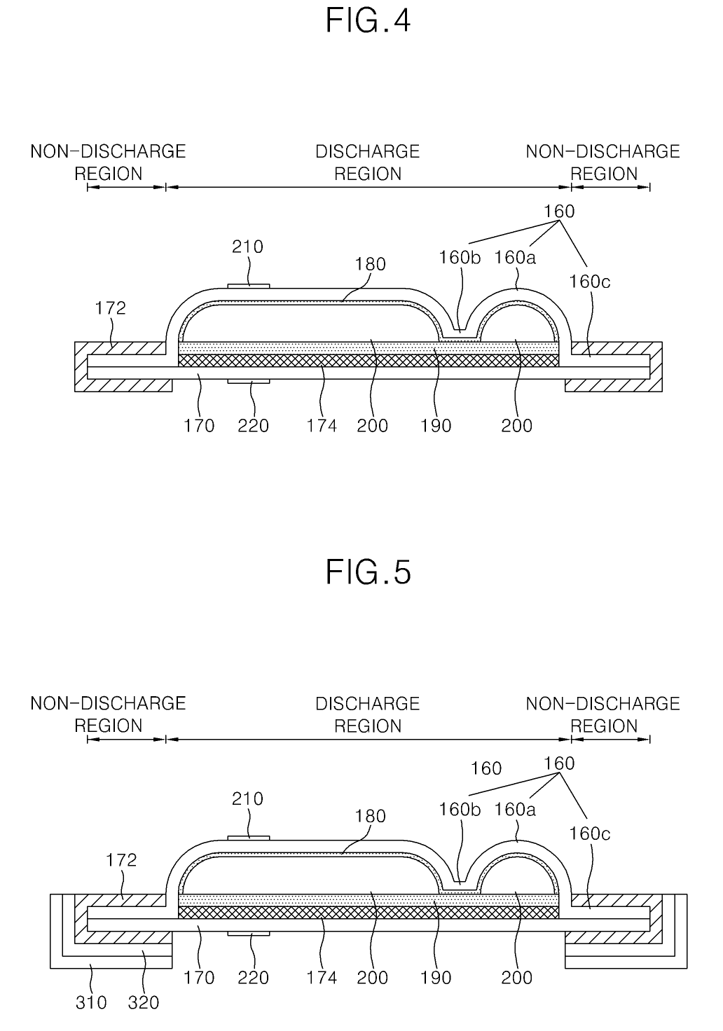

FIG. 4 is a cross-sectional view of an FFL according to a third exemplary embodiment of the present invention.

The FFL shown in FIG. 4 has the same configuration as that shown in FIG. 1 and FIG. 2, except that the sealing member encompasses the outer region of the first and second substrates, which contact each other. Therefore, a detailed description of the same elements will be omitted.

Referring to FIG. 4, the second substrate 170 has a planar surface in the discharge region and in the non-discharge region. The second substrate 170 in the non-discharge region contacts the plane portion 160c of the first substrate 160. The sealing member 172 is formed on exposed surfaces of the second substrate 170 in the non-discharge region and the plane portion 160c of the first substrate 160. To this end, the sealing member 172 may be coated on the exposed surfaces of the first and second substrates 160 and 170 in the non-discharge region at a high temperature. Thereafter, the sealing member 172 may be fixed to the first and second substrates 160 and 170 by using a forming bath 310 to which a release agent 320 is attached, as shown in FIG. 5. After the sealing member 172 is fixed to the first and second substrates 160 and 170, the release agent 320 is detached to separate the sealing member 172 and the forming bath 310.

As described above, in the FFL according to the third exemplary embodiment of the present invention, the first and second substrates 160 and 170 contact each other in the non-discharge region, and the sealing member 172 is formed on the exposed surfaces of the first and second substrates 160 and 170 in the non-discharge region. Therefore, the sealing member 172 is not exposed to the discharge space 200.

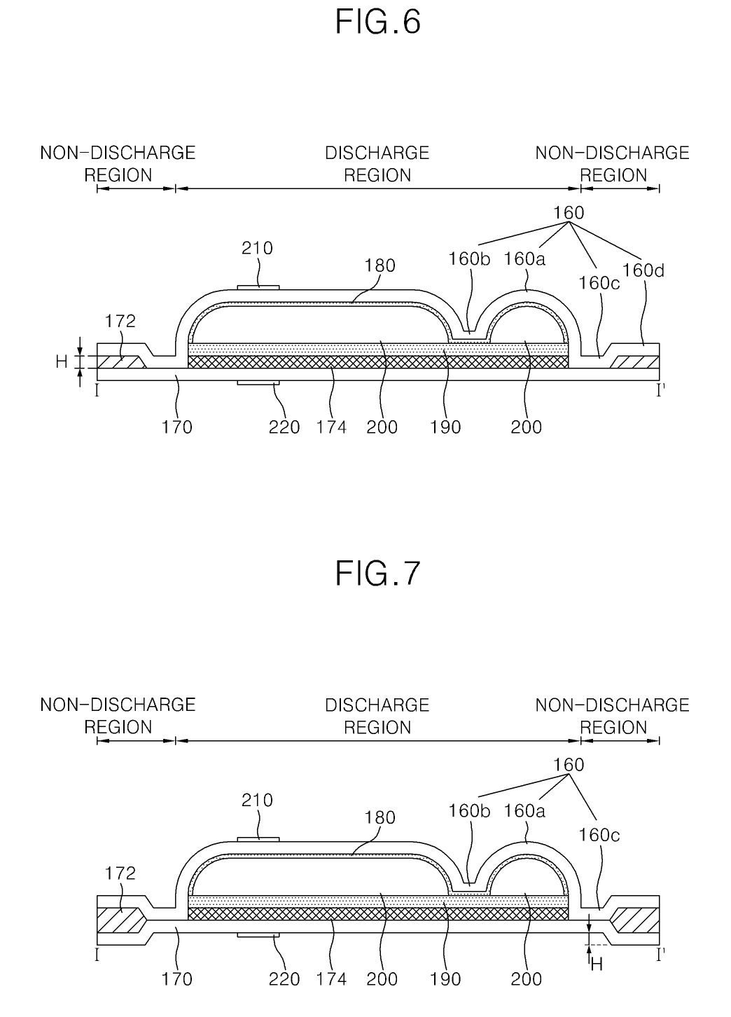

FIG. 6 is a cross-sectional view of an FFL according to a fourth exemplary embodiment of the present invention.

The FFL shown in FIG. 6 has the same configuration as that shown in FIG. 1 and FIG. 2, except that the second substrate has a planar surface in the non-discharge region and the first substrate includes a filling portion. Therefore, a detailed description of the same elements will be omitted.

Referring to FIG. 6, the first substrate 160 further includes a second filling portion 160d that is stepped with respect to the plane portion 160c in order to provide a region for forming the sealing member 172. For example, the second filling portion 160d may have a step height H of about 0.5 to 1 mm from the plane portion 160c. The plane portion 160c of the first substrate 160 contacts the second substrate 170, thereby preventing the sealing member 172 from being exposed to the discharge spaces 200. Additionally, as FIG. 7 shows, the FFL may include both the first filling portion 170b of the first substrate 170 and the second filling portion 160d of the second substrate 160. In other words, the region for forming the sealing member 172 may be formed with a step height in the first and second substrates 160 and 170 in the non-discharge region. Furthermore, in this case, the filling portions 160d and 170b of the first and second substrates 160 and 170, respectively, may form a closed space, similar to that shown in FIG. 3.

Therefore, in the FFL according to the fourth exemplary embodiment of the present invention, the first and second substrates 160 and 170 contact each other in the non-discharge region near the sealing member 172 formed at the second filling portion 160d having a step height. In this way, the sealing member 172 is not exposed to the discharge space.

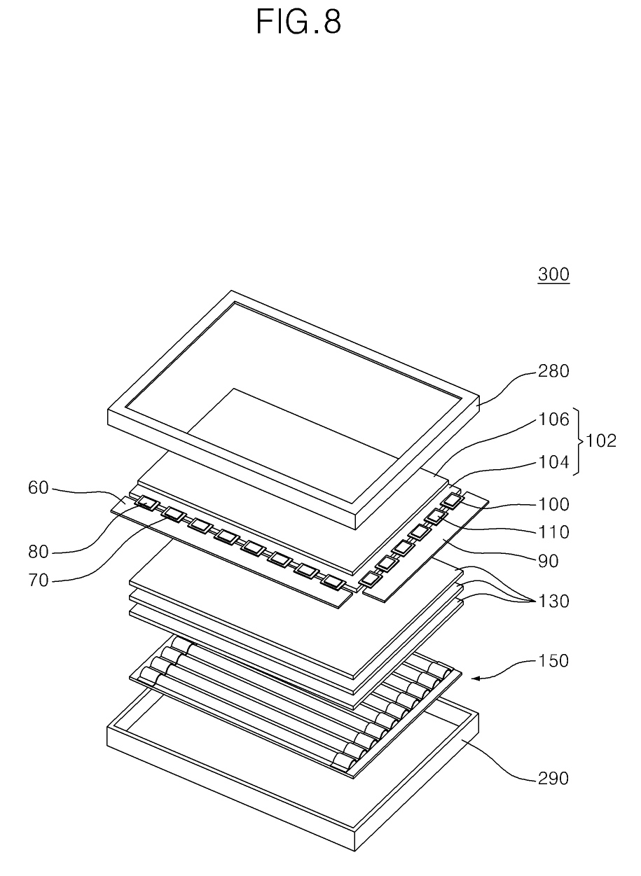

FIG. 8 is a perspective view of an LCD device having an FFL according to an exemplary embodiment of the present invention.

Referring to FIG. 8, an LCD device 300 includes an LCD panel 102 for displaying an image and the FFL 150 located behind the LCD panel 102.

The LCD panel 102 displays an image using light generated from the FFL 150. The LCD panel 102 includes a TFT substrate 104 and a color filter substrate 106 facing each other with liquid crystal disposed therebetween. A gate signal, which is generated by a gate driver integrated circuit (IC) 110 mounted on a gate tape carrier package (TCP) 100 connected to a gate printed circuit board (PCB) 90, is supplied to gate lines formed on the TFT substrate 104. A data signal, which is generated by a data driver IC 80 mounted on a data TCP 70 connected to a data PCB 60, is supplied to data lines formed on the TFT substrate 104.

The FFL 150 may include the elements shown in FIG. 1. FIG. 2, FIG. 3, FIG. 4, FIG. 6, and FIG. 7 and therefore a detailed description thereof will be omitted.

An optical member 130 is formed between the FFL 150 and the LCD panel 102 in order to improve luminance of light irradiated from the FFL 150 and uniformity of the luminance. The optical member 130 includes a diffuser sheet to diffuse light irradiated from the FFL, a prism sheet to collect light diffused from the diffusion sheet in a direction perpendicular to the LCD panel 102, and a protector sheet to protect the prism sheet from damage.

A case 290 holding the FFL 150 is coupled with a top chassis 280 formed to encompass an edge of the front of the LCD panel 102. The top chassis 280 prevents the LCD panel 102 from damage due to external shock and holds the LCD panel 102 in the case 290.

As is apparent from the foregoing description, the FFL and the LCD device having the same according to exemplary embodiments of the present invention include first and second substrates that contact each other in the non-discharge region. That is, a region of the first and/or second substrates of the FFL at which the sealing member is formed has a step height, or the sealing member is formed to encompass the outer region of the first and second substrates. Therefore, the FFL and the LCD device having the same according to the present invention may prevent the sealing member and the electrode partition from being exposed to the discharge space.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A flat fluorescent lamp, comprising:
a first substrate;
a second substrate facing the first substrate, the first substrate and the second substrate comprising a discharge region comprising a plurality of discharge spaces and a non-discharge region;
a fluorescent layer arranged in the discharge spaces on at least one of the first substrate and the second substrate; and
a sealing member arranged in the non-discharge region, the sealing member being shielded from the discharge spaces and coupling the first substrate with the second substrate.

2. The flat fluorescent lamp of claim 1, wherein at least one of the first substrate and the second substrate has a portion where the sealing member is arranged that has a step height with respect to another portion of the at least one substrate where the sealing member is not arranged.

3. The flat fluorescent lamp of claim 2, wherein the sealing member is arranged in an open space between the first substrate and the second substrate.

4. The flat fluorescent lamp of claim 2, wherein the sealing member is arranged in a closed space between the first substrate and the second substrate.

5. The flat fluorescent lamp of claim 2, wherein the step height is in a range of 0.5 mm to 1 mm.

6. The flat fluorescent lamp of claim 1, wherein the sealing member is arranged on an exposed surface of the first substrate and the second substrate.

7. The flat fluorescent lamp of claim 1, wherein the first substrate comprises space providers spaced apart from the second substrate to provide the discharge spaces, and space partitions arranged between the space providers to partition the discharge spaces.

8. The flat fluorescent lamp of claim 7, further comprising electrodes crossing the discharge spaces and facing each other.

9. The flat fluorescent lamp of claim 8, wherein the sealing member is arranged between the second substrate and the space partitions of the first substrate, the sealing member overlapping with the electrodes.

10. The flat fluorescent lamp of claim 1, wherein the non-discharge region encompasses the discharge region.

11. A liquid crystal display device, comprising:
a flat fluorescent lamp; and
a liquid crystal display panel to display an image with light from the flat fluorescent lamp,
wherein the flat fluorescent lamp comprises:
a first substrate;
a second substrate facing the first substrate to provide a discharge region comprising a plurality of discharge spaces and a non-discharge region encompassing the discharge region;
a fluorescent layer arranged in the discharge spaces on at least one of the first substrate and the second substrate; and
a sealing member arranged in the non-discharge region, the sealing member being shielded from the discharge spaces and coupling the first substrate with the second substrate.

12. The liquid crystal display device of claim 11, wherein at least one of the first substrate and the second substrate has a portion where the sealing member is arranged that has a step height with respect to another portion of the at least one substrate where the sealing member is not arranged.

13. The liquid crystal display device of claim 12, wherein the sealing member is arranged in an open space between the first substrate and the second substrate.

14. The liquid crystal display device of claim 12, wherein the sealing member is arranged in a closed space between the first substrate and the second substrate.

15. The liquid crystal display device of claim 12, wherein the step height is in a range of 0.5 mm to 1 mm.

16. The liquid crystal display device of claim 11, wherein the sealing member is arranged on an exposed surface of the first substrate and the second substrate.

17. The liquid crystal display device of claim 11, wherein the first substrate comprises space providers spaced apart from the second substrate to provide the discharge spaces, and space partitions arranged between the space providers to partition the discharge spaces.
